(19) United States
(12) Patent Application Publication
(10) Pub. No.: US 2023/0161364 A1
(43) Pub. Date: May 25, 2023

(54) LINEAR REGULATOR

(71) Applicant: Tagore Technology, Inc., Arlington Heights, IL (US)

(72) Inventors: Rajesh GHOSH, Hooghly (IN); Pramit SARKAR, Kolkata (IN); Syed Asif EQBAL, Patna (IN)

(21) Appl. No.: 17/530,569

(22) Filed: Nov. 19, 2021

(51) Int. Cl. G05F 1/56; H02M 1/00; H02M 3/156

(52) U.S. Cl. CPC G05F 1/562; H02M 1/0025; H02M 1/0029; H02M 3/1563

(57) ABSTRACT

A gallium nitride (GaN) transistor-based regulated voltage source has a reference voltage input coupled to a reference voltage. The regulated voltage source also includes an input port and an output port. The regulated voltage source includes a GaN transistor-based voltage regulation path coupling the input port and the output port with at least a GaN regulation transistor with a threshold voltage and that is formed on a substrate. The regulated voltage source also includes a GaN transistor-based voltage compensator having an intermediate GaN transistor that is also formed on the substrate. The GaN transistor-based voltage compensator couples a gate of the GaN regulation transistor to the reference voltage input and introduces a voltage drop between the gate of the GaN regulation transistor and the reference voltage input to compensate for the threshold voltage of the GaN regulation transistor.

### BACKGROUND

### Field

This invention relates generally to regulated voltage supplies, and more specifically to gallium nitride (GaN) transistor-based regulated power supply circuits.

### Related Art

Voltage regulators operate to receive electrical power at varying voltages, such as from an unregulated power source, and produce electrical power with a constant, defined, voltage. Voltage regulators often use a voltage reference source that produces a consistent and known voltage but generally with only a small amount of electrical current. Voltage regulators often include circuitry to produce an electrical power output at a determined voltage with an appreciable amount of electrical current to supply various circuits.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 illustrates a high-level diagram a GaN transistor-based regulated voltage source, according to an example.

FIG. 2 illustrates an example GaN transistor-based regulated voltage source circuit, according to an example

FIGS. 3-5 illustrate alternative GaN transistor-based regulated voltage source circuits, according to various examples.

FIG. 6 illustrates a fourth alternative GaN transistor-based regulated voltage source circuit, according to an example.

FIG. 7 illustrates a fifth alternative GaN transistor-based regulated voltage source circuit, according to an example.

FIG. 8 illustrates a sixth alternative GaN transistor-based regulated voltage source circuit, in accordance with an example.

FIG. 9 illustrates input filtered alternative GaN transistor-based regulated voltage source circuits, according to an example.

FIG. 10 illustrates a GaN transistor-based voltage regulator with lower reference, according to an example.

FIGS. 11 and 12 illustrate first and second alternative GaN transistor-based voltage regulators with lower references, respectively, according to examples.

FIG. 13 illustrates a sixth alternative GaN transistor-based regulated voltage source circuit, according to an example.

### DETAILED DESCRIPTION

The below described voltage regulators receive a raw/unregulated input voltage from an input power supply and provides a regulated voltage output with appreciable electrical current. In an example, a voltage regulator receives unregulated electrical power and a voltage reference signal and then produces a regulated output voltage to a gallium nitride (GaN) gate driver. In various examples, voltage regulators are able to provide one output with a fixed, regulated, voltage, or have multiple outputs that each provide its own different fixed, regulated voltage. These voltage regulators are able to provide regulated voltages to any suitable load within the electrical current capacity of the regulator.

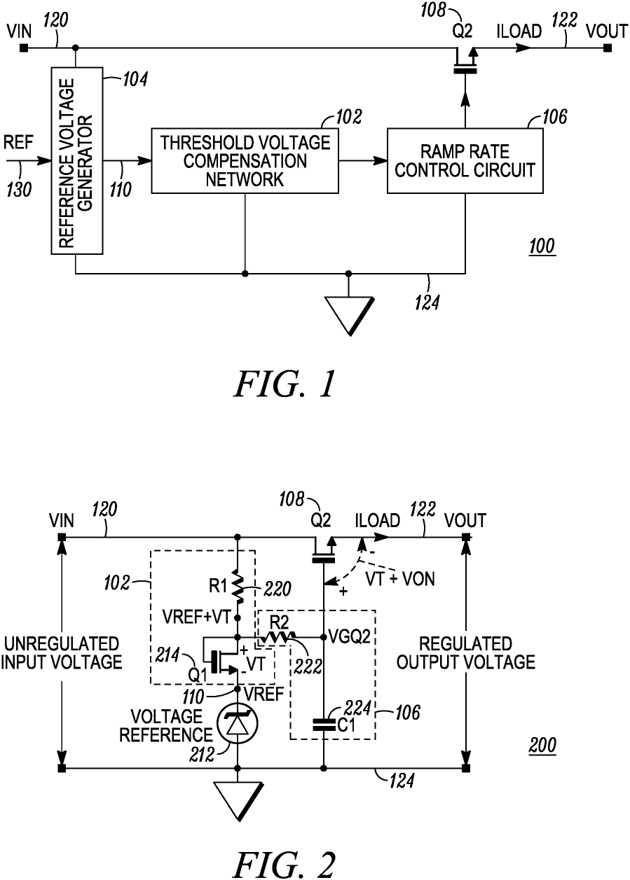

FIG. 1 illustrates a high-level diagram a GaN transistor-based regulated voltage source 100, according to an example. The depicted example GaN transistor-based regulated voltage source 100 has a voltage input port 120 that receives an unregulated input voltage, a voltage output port 122 that provides a regulated output voltage, a threshold voltage compensation network 102, a reference voltage generator 104, a ramp rate controller circuit 106, and a GaN regulation transistor 108. The reference voltage generator 104 in an example receives a reference voltage input 130 and provides a reference voltage to a reference input 110 of the threshold voltage compensation network 102 to support deriving appropriate internal references to regulate its output voltages at the desired levels. In further examples, the reference voltage generator is able to have its own voltage reference and not use a reference voltage input 130.

In an example, the GaN regulation transistor 108 is a GaN high electron mobility transistor (HEMT). Challenges of using GaN HEMT devices in an output stage of a voltage regulator include wide variations in the threshold voltage of GaN HEMT devices that are dependent upon its manufacturing process. The threshold voltages of different GaN HEMT devices are able to vary in some cases by, for example, 0.5 V to 2.2 V. However, the threshold voltage of all the GaN HEMTs on the same die is within a reasonable range. In order to address these variations, the threshold voltage compensation network 102 includes an intermediate GaN transistor that is formed on the same substrate as the GaN regulation transistor 108. In some examples, these GaN transistors are devices, such as GaN HEMTs, resistors and capacitors, that are able to be fabricated by commercially available GaN processes. In some examples, MOS P-type transistors or equivalent devices are not used.

In some instances, such as during startup/power up and power down of circuits, the input voltages at the voltage input port 120 of the GaN transistor-based regulated voltage source 100 can rise up or fall down with a fast ramp rate. The loads or circuits receiving electrical power from the output of the regulator might be sensitive to high ramp rates. In order to protect the loads or circuits from such high ramp rates, the illustrated GaN transistor-based regulated voltage source 100 includes the ramp rate control circuit 106 to control its output voltage ramp rate to a slower or controlled ramp rate during times such as startup and power down.

The reference voltage generator 104 in various examples is able to have any suitable design. In some examples, the reference voltage generator 104 is able to have a reference voltage input 130 that is connected to a voltage reference source (not shown) that produces a reference voltage. In an example, the voltage reference source (not shown) is able to be connected between the reference voltage input 130 and ground 124. Such a reference voltage is able to be generated by utilizing, for example, a Zener diode, a voltage reference IC, a DC voltage source, a silicon diode or transistor, a potential divider network, a BandGap voltage Reference (BGR), any other known methods, or combinations of these. In various examples, one or more devices producing the reference voltage are able to be integrated with other components of the GaN transistor-based regulated voltage source 100; are able to be implemented as separate non-GaN components or devices; or combinations of these.

In further examples, the reference voltage source (not shown), such as those described above, is able to be connected between the voltage input port 120 and the reference input 110. In some examples, the reference voltage generator 104 itself is able to include a voltage reference source and not rely on a reference voltage input 130. The voltage reference source (not shown) in various examples is able to be one or more current references, voltage references, or a combination of current and voltage references. In some examples, a current reference is able to be realized using a current source IC, a BGR, using any other suitable method, or combinations of these. In various examples, one or more devices producing the reference voltage are able to be integrated with other components of the GaN transistor-based regulated voltage source 100; are able to be implemented as separate non-GaN components or devices; or combinations of these.

In various examples, as is described in further detail below, the value or magnitude of a reference voltage used by the reference voltage generator 104, whether internal or external to the reference voltage generator 104, is able to be lower than, equal to, or higher than the output voltage produced at the voltage output port 122. It is also to be understood that current source references (not shown) are able to be used to generate reference voltages that are able to be of any value.

The GaN transistor-based regulated voltage source 100 shows that the reference voltage generator 104 provides a reference voltage signal to a reference input 110 of the threshold voltage compensation network 102. The threshold voltage compensation network 102 in an example adds a small voltage component to the reference voltage signal received from the reference voltage generator 104 through the reference input 110 to compensate for the threshold voltage that is present in the GaN regulation transistor 108. Because the threshold voltage compensation network 102 in some examples includes an intermediate GaN transistor that is formed on the same die, and thus the same substrate, as the GaN regulation transistor 108, the threshold voltage compensation network 102 is able to accurately compensate for the threshold voltage of the GaN regulation transistor 108.

The compensated voltage reference produced by the threshold voltage compensation network 102 in the illustrated example is passed through the ramp rate control circuit 106. The illustrated ramp rate control circuit 106 is an example of a ramp rate control block that couples the intermediate GaN transistor and the GaN regulation transistor and is configured to operate in an example so as to limit or slow down the ramp rate of the gate voltage that is provided to GaN regulation transistor 108. That threshold voltage compensated and ramp rate controlled reference voltage is applied to the gate terminal of the GaN regulation transistor 108.

In various embodiments, the reference voltage generator 104, the threshold voltage compensation network 102, and the ramp rate control circuit 106 are able to be connected in any order or sequence. For example, the ramp rate control circuit 106 can be connected before the threshold voltage compensation network 102. In various examples, elements of one or more of these components are able to be incorporated into other of these components. For example, elements of the ramp rate control circuit 106 are able to be incorporated into the threshold voltage compensation network 102.

FIG. 2 illustrates a GaN transistor-based regulated voltage source circuit 200, according to an example. The GaN transistor-based regulated voltage source circuit 200 depicts electrical circuit components of an example that realizes the GaN transistor-based regulated voltage source 100 described above. In further examples, the GaN transistor-based regulated voltage source 100 is able to be implemented by any other suitable circuit design.

The GaN transistor-based regulated voltage source circuit 200 depicts the voltage input port 120, GaN regulation transistor 108, voltage output port 122 and ground 124 of the GaN transistor-based regulated voltage source 100. Various circuit elements are shown in this example that make up the threshold voltage compensation network 102 and the ramp rate control circuit 106.

The Zener diode 212 in the GaN transistor-based regulated voltage source circuit 200 operates as a reference voltage source 130 that, in this example, also operates as the reference voltage generator 104 that provides a reference voltage to the reference input 110 of the threshold voltage compensation network 102. In this example, this reference voltage is provided relative to ground 124. The GaN regulation transistor Q2 108 is the main GaN HEMT and carries the load current ILoad that is provided to the voltage output port 122.

Resistor R1 220 and intermediate GaN transistor Q1 214 are elements of the threshold voltage compensation network 102. Resistor R1 220 provides a bias current to Zener diode 212. The intermediate GaN transistor Q1 214 is an auxiliary GaN HEMT device that is configured to operate as a GaN diode with its gate and drain shorted together. In operating as a GaN diode, the voltage drop between the source and drain of the intermediate GaN transistor Q1 214 is approximately equal to, and thus compensates for, the threshold voltage (VT) of the GaN regulation transistor 108.

The ramp rate control circuit 106 in this example is formed by the second resistor R2 222 and capacitor C2 224, which form a lowpass filter. This low pass filter controls the ramp rate of the gate voltage presented to the GaN regulation transistor Q2 108, and hence, the ramp rate of the output voltage. In some examples, capacitor C2 224 is able to be realized by using GaN HEMT capacitance, by any other capacitor, or by combinations of these.

The operation of the GaN transistor-based regulated voltage source circuit 200 is as follows. As unregulated input voltage VIN is applied to the voltage input port 120, a bias current to the Zener diode 212 flows through resister R1 220 and the intermediate GaN transistor Q1 214. The voltage reference at the reference input 110 is then fixed at voltage VREF, which is the Zener voltage VZ in this example.

The voltage at the drain of the intermediate GaN transistor Q1 214 is equal to the sum of the Zener voltage of the Zener diode 212 and the threshold voltage of the intermediate GaN transistor Q1 214, i.e., VREF+VT. That voltage is passed through the low pass filter formed by the second resistor R2 222 and capacitor C1 224 to the gate terminal of the GaN regulation transistor Q2 108. That filter controls the ramp rate of voltage presented to the gate terminal of the GaN regulation transistor Q2 108. After a delay set by the values of the second resister R2 222 and capacitor C1 224, the voltage on the gate terminal of the GaN regulation transistor Q2 108 equals the sum of the Zener voltage of the Zener diode 212 and the threshold voltage of the intermediate GaN transistor Q2 214.

The voltage at the source of the GaN regulation transistor Q2 108 follows its gate voltage, VGQ2, but the voltage at the source of the GaN regulation transistor Q2 108 is (VT+VON) volts lower than its gate voltage VGQ2, where VON is the conduction voltage drop of the GaN regulation transistor Q2 108. The conduction voltage drop VON is a function of the channel resistance, Rds_on, of the GaN HEMT transistor and of the load current passing through the transistor.

In the steady state, VOUT at the voltage output port = VREF + VT - VT - VON =VREF - VON.

The voltage drop VON is typically small, and can be controlled by adjusting the width of the GaN regulation Q2 108 that is formed on a substrate to meet the desired output voltage tolerance specification. As is clear from the above, the voltage present at the voltage output port 122 is maintained at VOUT ≈ VREF.

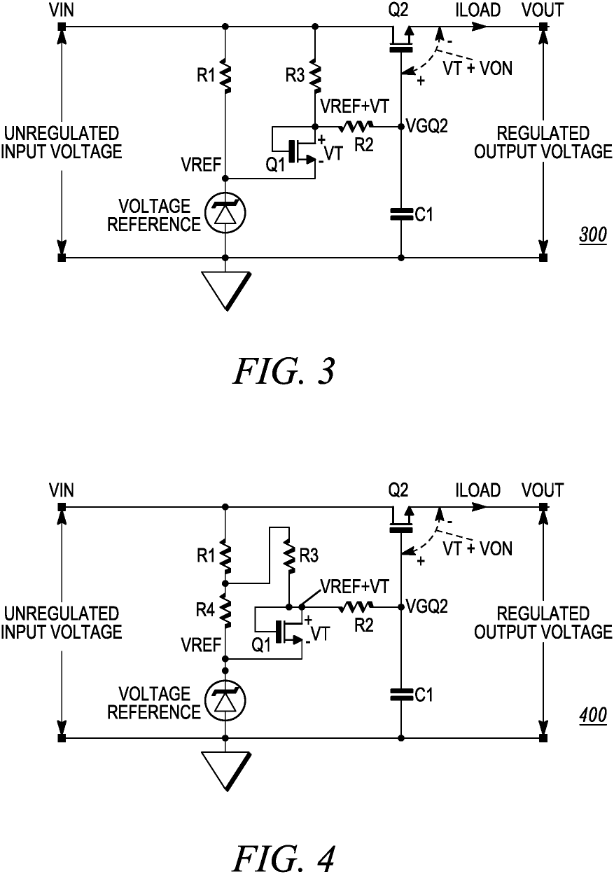

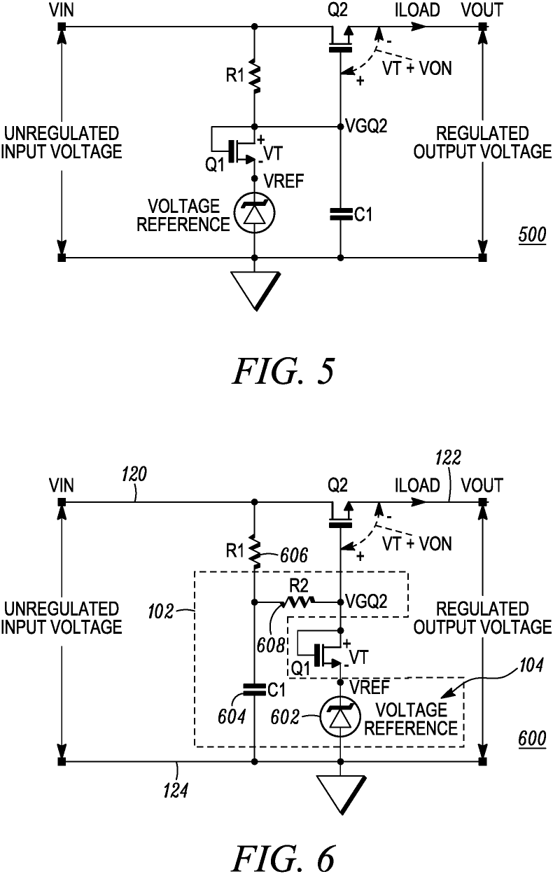

FIGS. 3-5 illustrate alternative GaN transistor-based regulated voltage source circuits, according to various examples. FIG. 3 illustrates a first alternative GaN transistor-based regulated voltage source circuit 300, FIG. 4 illustrates a second alternative GaN transistor-based regulated voltage source circuit 400, and FIG. 5 illustrates a third alternative GaN transistor-based regulated voltage source circuit 500. These example alternative GaN transistor-based regulated voltage source circuits 300, 400, and 500 illustrate realizations of a GaN transistor-based regulated voltage source that use alternative circuit topologies. In further examples, one or more capacitors are able to be connected across any particular resistor or a number of resistors to speed up response times to variations in various voltages such as during startup.

FIG. 6 illustrates a fourth alternative GaN transistor-based regulated voltage source circuit 600, according to an example. The fourth alternative GaN transistor-based regulated voltage source circuit 600 includes components of the ramp rate control circuit 106, which includes resistor 608 and capacitor 604, rearranged to be included in the reference voltage generator 104, which in this example is Zener diode 602. The fourth alternative GaN transistor-based regulated voltage source circuit 600 supplies bias current for the Zener diode 602 from the output of an RC filter formed by capacitor 604 and resistor R1 606 and R2 608.

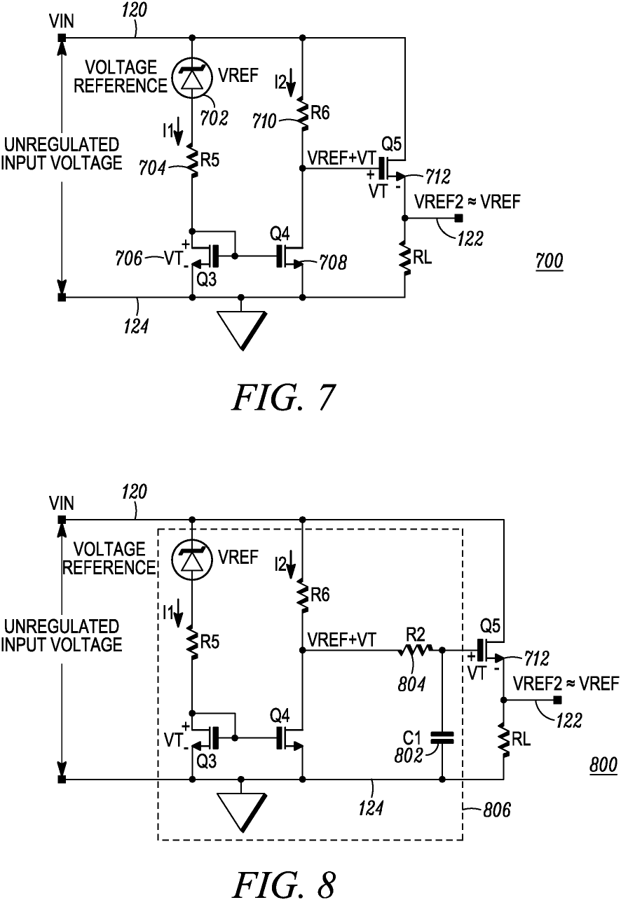

FIG. 7 illustrates a fifth alternative GaN transistor-based regulated voltage source circuit 700, according to an example. The fifth alternative GaN transistor-based regulated voltage source circuit 700, as is true for other circuits described herein, is able to produce a regulated voltage at its voltage output port 122 that is able to supply a regulated voltage to an electrical load or the voltage present at the voltage output port 122 is able to be uses as a reference voltage for a further stage of a voltage regulator circuit, or both.

The fifth alternative GaN transistor-based regulated voltage source circuit 700 connects the positive terminal of its voltage reference, i.e., Zener diode 702 in this example, to the positive terminal of the voltage input port 120. The fifth alternative GaN transistor-based regulated voltage source circuit 700 operates to generate a voltage VREF+VT at the gate terminal of the GaN regulation transistor Q5 712. The source of the GaN regulation transistor Q5 712 provides another voltage reference VREF2 at the voltage output port 122 with respect to ground 124. The value of the voltage reference VREF2 at the voltage output port 122 in this example is equivalent to the voltage reference VREF that is the Zener voltage of the Zener diode 702. The fifth alternative GaN transistor-based regulated voltage source circuit 700 advantageously allows a reference voltage generator, such as the Zener diode 702, to be connected to the positive terminal of the regulator’s voltage input port 120.

The fifth alternative GaN transistor-based regulated voltage source circuit 700 includes a current copier circuit using two GaN HEMTs, a first internal GaN transistor Q3 706 and a second internal GaN transistor Q4 708. The electrical current I1 that flows through the first resistor R5 704 equals (VIN - VREF - VT)/R5. In the illustrated example, the value of the first resister R5 704 is equal to the value of the second resistor R6 710, such that R6 = R5. That electrical current is copied through the second internal GaN transistor Q4 708 as I2. Therefore, I2 = I1 = (VIN - VREF - VT)/R5.

The voltage at drain of the second internal GaN transistor Q4 708 is equal to VIN -I2*R5 = VREF + VT. The voltage at the source of the GaN regulation transistor Q5 712, i.e., VREF2, follows its gate voltage of the GaN regulation transistor Q5 712 by an amount that is approximately less than one threshold voltage VT. Therefore, VREF2 ≈VREF.

In the fifth alternative GaN transistor-based regulated voltage source circuit 700, the GaN regulation transistor Q5 712 also acts as a buffer and can source higher current to the voltage output port 122 without disturbing the original reference voltage input. Further variations of the fifth alternative GaN transistor-based regulated voltage source circuit 700 are also able to be realized, such as using either VREF2 and/or VREF+VT as a reference voltage for other circuits. In further examples, the first resistor R5 704 that is in series with the first internal GaN transistor Q3 706 and the second resistor R6 710 that is in series with the second internal GaN transistor Q4 708 are able to be specified to have different values in order to achieve a desired voltage gain at the gate terminal of the GaN regulation transistor Q5 712. In further examples, a separate biasing resistor (not shown) can be connected from the anode of Zener diode 702 to ground 124. In another example, the GaN regulator transistor Q5 712 is able to be specified to supply electrical current to an electrical load and operate as a main series pass regulator GaN HEMT, with the load connected to the voltage output port.

FIG. 8 illustrates a sixth alternative GaN transistor-based regulated voltage source circuit 800, in accordance with an example. The sixth alternative GaN transistor-based regulated voltage source circuit 800 integrates the ramp rate control circuit, implemented by a first resistor R2 804 and a capacitor C1 802 together with its internal voltage reference circuit 806.

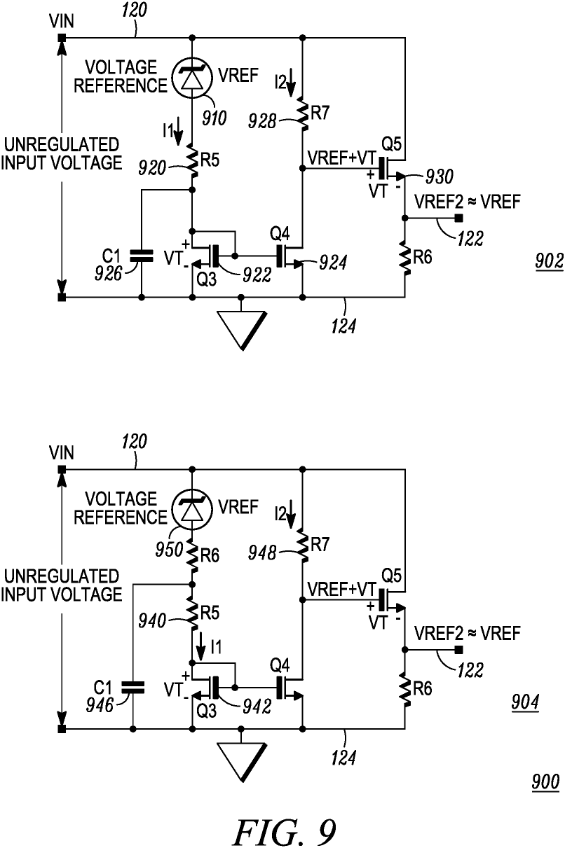

FIG. 9 illustrates input filtered alternative GaN transistor-based regulated voltage source circuits 900, according to an example. The input filtered alternative GaN transistor-based regulated voltage source circuits 900 depicts a seventh alternative GaN transistor-based regulated voltage source circuit 902 that connects capacitor C1 926 across a first internal GaN transistor Q3 922 in order to affect the ramp rate of the voltage across the first internal GaN transistor Q3 922, and thus the voltage at the gate terminal of the GaN regulation transistor Q5 930. In some examples, the first resistor R5 920 and the second resistor R7 928 have equal values. In further examples, the first resistor R5 920 and the second resistor R7 928 are able to be given different values by designers to vary the relationship between the values of the Zener diode voltage VREF and the voltage present on the gate terminal of the GaN regulation transistor Q5 930, thereby allowing any value of VREF2 at the voltage output port 122 and not limiting that output voltage value to the value of VREF which is the Zener voltage of the Zener diode 910.

The input filtered alternative GaN transistor-based regulated voltage source circuits 900 also depicts an eighth alternative GaN transistor-based regulated voltage source circuit 904 that connects capacitor C1 946 across the series connected first internal GaN transistor Q3 942 and first resistor R5 940 in order to limit the ramp rate of voltages across the first internal GaN transistor Q3 942 and thus the ramp rate of the voltage at the voltage output port 122 as discussed above with respect to the seventh alternative GaN transistor-based regulated voltage source circuit 902.

As discussed above with regards to the first resistor R5 920 and the second resistor R7 928 of the seventh alternative GaN transistor-based regulated voltage source circuit 902, the values of the first resistor R5 940 and the second resistor R7 948 of the eighth alternative GaN transistor-based regulated voltage source circuit 904 are able to similarly have equal values or different values. In various other examples the internal GaN transistors Q3 and Q4 of the of the seventh alternative GaN transistor-based regulated voltage source circuit 902, the eighth alternative GaN transistor-based regulated voltage source circuit 904, or both, are able to be the same type of transistor or are able to be different types of transistors.

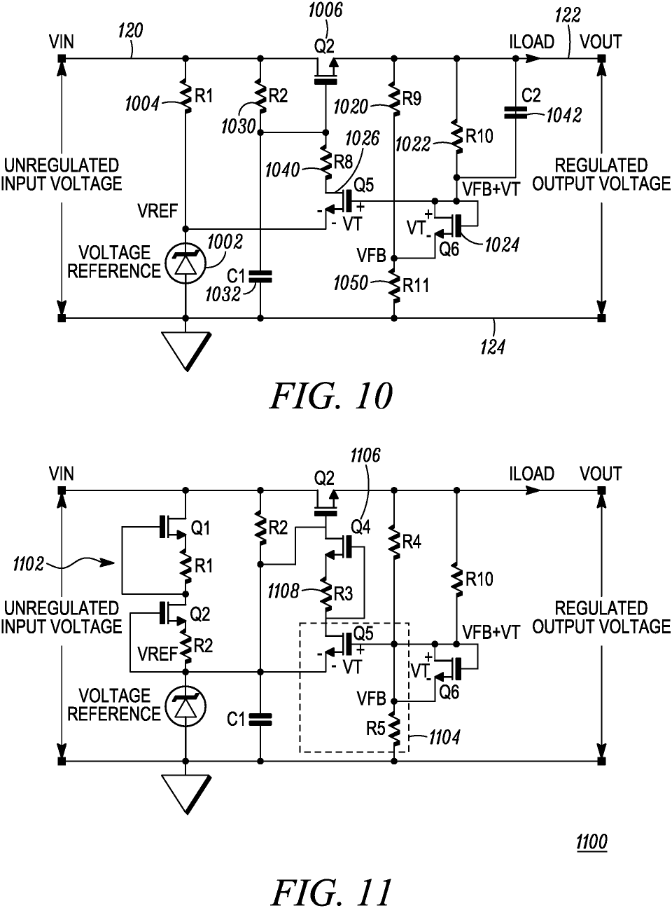

FIG. 10 illustrates a GaN transistor-based voltage regulator with lower reference 1000, according to an example. The GaN transistor-based voltage regulator with lower reference 1000 operates with an input reference voltage VREF that is less than the regulated output voltage VOUT provided at the voltage output port 122. In the illustrated example, the GaN transistor-based voltage regulator with lower reference 1000 includes a first resistor R9 1020 and a second resistor R11 1050 that are configured as a potential divider. This potential divider is an example of an output voltage adjuster that is configured to, when operating, reduce the regulated output voltage to the reference voltage for comparison to a voltage on the reference voltage input. For a specified output voltage VOUT to be delivered to the voltage output port 122, the values of the first resister R9 1020 and the second resistor R11 1050 in this voltage potential divider are selected so that the voltage at their mid-point voltage is reduced to a value that is set be VFB = VREF, which is the Zener voltage of the Zener diode 1002. The incorporation of this voltage potential divider to reduce the voltage present at the voltage output port 122 advantageously allows that output voltage to be compared to a lower input references voltage and thus allows the GaN transistor-based voltage regulator with lower reference 1000 to provide a regulated output voltage that is greater than its reference input voltage. In general, voltages produced at any mid-point of a voltage potential divider structure are able to be compared to any suitable reference voltage that is lower than the voltage desired to be produced at the voltage output port 122.

The GaN transistor-based voltage regulator with lower reference 1000 includes an auxiliary GaN HEMT Q6 1024. In an example, the value of a third resistor R10 1022 is much greater than the value of the first resistor R9 1020, i.e., R10 » R9, and the auxiliary GaN HEMT Q6 1024 is biased through the high-valued third resistor R10 1022. In some examples, the third resistor R10 1022, auxiliary GaN HEMT Q6 1024, and first resistor R9 1020, can be part of the potential divider itself.

The voltage drop VT across the auxiliary GaN HEMT Q6 1024 in the illustrated GaN transistor-based voltage regulator with lower reference 1000 compensates for the threshold voltage VT of a second auxiliary GaN HEMT Q5 1026. The auxiliary GaN HEMT Q6 1024 is an example of an intermediate GaN transistor that couples an output of the output voltage adjuster to the gate terminal of the GaN regulation transistor to introduce a voltage increase between the output of the output voltage adjuster and the gate terminal of the GaN regulation transistor, where the voltage increase is based on the voltage drop introduced by the second intermediate GaN HEMT Q5 1026.

The conduction drop VON for both the second auxiliary GaN HEMT Q5 1026 and the auxiliary GaN HEMT Q6 1024 are able to be neglected in this example due to their low drain currents. A sixth resistor R2 1030 and first capacitor C1 1032 function as the ramp rate control circuit 106. In further examples, the GaN transistor-based voltage regulator with lower reference 1000 is able to be implemented with a fourth resistor R8 1040 being replaced with short. A second capacitor C2 1042 speeds up the feedback signal and in some examples is able to not be present.

The operation of the GaN transistor-based voltage regulator with lower reference 1000 is as follows. An input voltage VIN is applied to the voltage input port 120. In general, the input voltage will ramp up from zero. A fifth resistor R1 1004 biases the Zener diode 1002, thereby establishing VREF at the source of the second auxiliary GaN HEMT Q5 1026. The second auxiliary GaN HEMT Q5 2016 is initially off. The input voltage VIN at the voltage input port 120, after slewing through the sixth resistor R2 1030 and the first capacitor C1 1032, is present at the gate terminal of the GaN regulation transistor Q2 1006. The output voltage present at the voltage output port 122 follows the gate voltage of GaN regulation transistor Q2 1006 at a value that is one threshold voltage VT below its gate voltage. As the feedback signal VFB at the source of the first auxiliary GaN HEMT Q6 1024 tries to exceed the Zener voltage VREF of the Zener diode 1002, the second auxiliary GaN HEMT Q5 1026 starts conducting and starts pulling the gate voltage of the GaN regulation transistor Q2 1006 downward. The feedback signal VFB at the source of the first auxiliary GaN HEMT Q6 1024 then settles around VREF, which is the Zener voltage of the Zener diode 1002, and the output voltage settles around the desired voltage VOUT.

In some examples, circuits similar to the GaN transistor-based voltage regulator with lower reference 1000 are able to be realized by rearranging resistive elements, removing or rearranging capacitive elements, or combinations of these. For example, the second capacitor C2 1042 is able to be removed.

In some examples, the GaN transistor-based voltage regulator with lower reference 1000 is able to be used as a reference level enhancer, where VOUT at the voltage output port 122 is able to be used as a derived voltage reference, which in turn is able to be at a higher level than the reference VREF used by the GaN transistor-based voltage regulator with lower reference 1000. By adjusting the first resistor R9 1020 and the second resistor R11 1050, the derived reference VOUT provided at the voltage output port 122 is able to be set to any desired level, including values that are above the VREF used by that circuit.

FIG. 11 illustrates a first alternative GaN transistor-based voltage regulator with lower reference 1100, according to an example. The first alternative GaN transistor-based voltage regulator with lower references 1100 is similar to the above-described GaN transistor-based voltage regulator with lower references 1000 where the Zener biassing resistor R1 1004 is replaced by a biasing network 1102 that includes depletion HEMTs Q1 and Q2 and resistors R1 and R2. This configuration operates to improve Zener regulation and reduces circuit area. The first alternative GaN transistor-based voltage regulator with lower reference 1100 also includes an error amplifier 1104 that includes enhancement-HEMT Q5 and resistor R5 resistor. The fourth resistor R8 1040 of the GaN transistor-based voltage regulator with lower reference 1000 is also replaced by a network including depletion HEMT Q4 1106 and R3 1108. These alternative aspects allow achieving more impedance thus higher gain, also saves the area compared to using resistive networks.

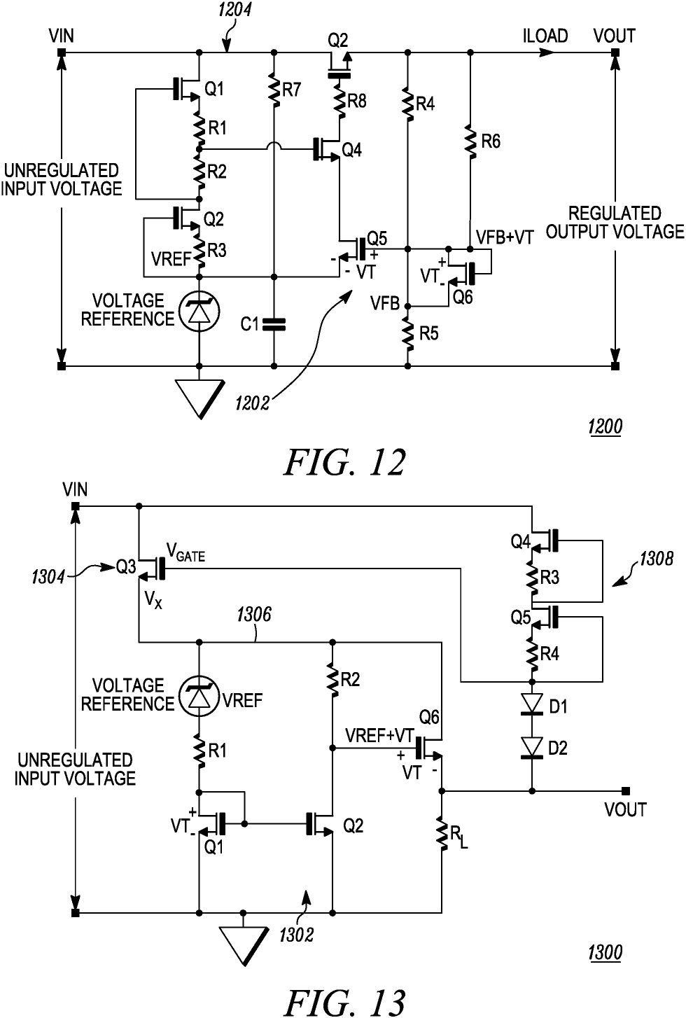

FIG. 12 illustrates a second alternative GaN transistor-based voltage regulator with lower reference 1200, according to an example. The second alternative GaN transistor-based voltage regulator with lower reference 1200 is similar to the above-described GaN transistor-based voltage regulator with lower references 1000 and the first alternative GaN transistor-based voltage regulator with lower reference 1100. With regards to the GaN transistor-based voltage regulator with lower references 1000, the second alternative GaN transistor-based voltage regulator with lower references 1200 replaces the Zener biassing resistor R1 1004 by a biasing network 1204 that includes depletion HEMTs Q1 and Q2 and resistors R1, R2, and R3. An error amplifier 1202 for the linear regulator is provided by a cascode amplifier formed by Q4, Q5 and R8. This structure improves the bandwidth of the error amplifier thus improving the transient performance of the regulator and enhances the resistance of the error amplifier 1202. The enhancement-HEMT Q5 is the input transistor of this error amplifier 1202 and Q4 is the cascode transistor which gets it bias from the network formed by Q1, R1 and R2.

FIG. 13 illustrates a sixth alternative GaN transistor-based regulated voltage source circuit 1300, according to an example. The sixth alternative GaN transistor-based regulated voltage source circuit 1300 is similar to the fifth alternative GaN transistor-based regulated voltage source circuit 700. In this example, an internal current mirror 1302 includes Q1, Q2 and pass-FET Q6 receives the regulated voltage Vx 1306, which is regulated by depletion HEMT Q3 1304. In this example, depletion HEMT Q3 1304 receives its bias from a bias network 1308 that is formed by Q4, R3, Q5, R4, D1 and D2. In this example, Q4 and Q5 are depletion HEMTs. The gate voltage of depletion HEMT Q3, i.e., Vgate, is:

$$\text{Vgate} = \text{Vout} + \text{Vd1} + \text{Vd2}$$

$$= \text{Vref} + \text{Vd1} + \text{Vd2}$$

Returning to the GaN transistor-based regulated voltage source 100, the voltage reference, such as the reference voltage input 130 provided to the reference voltage generator 104 or equivalent structures in any of the above-described circuits, is in general able to be of any suitable design. For example, current sources are able to be used with a series resistor to produce a reference voltage across the series resistor. In an example, an external current reference and an associated resistor (not shown) that form a current loop to generate the reference voltage across the associated resistor are able to be connected either between the voltage input port 120 and the reference voltage input 130 (i.e., high-side), or between the reference voltage input 130 and ground 124 (i.e., low-side). In examples that incorporate a high-side current reference, the transformed voltage generated across the associated resistor is able to be set with respect to ground and can be readily used as the desired voltage reference.

In some examples, a multi-output GaN transistor-based regulated voltage source is able to be created by integrating any combination of any number of the above-described GaN transistor-based regulated voltages sources. In one such example, each output voltage of the different GaN transistor-based regulated voltage sources is able to be of the same or of different magnitudes from one another. Different reference generator circuits are able to be used to generate appropriate voltage references from a common reference input, which is able to be a voltage or a current reference, or a combination of both. Further, some output voltage levels could be of higher magnitude than the reference voltage, while other outputs could be either same or less than the reference voltage. In some examples, one or more of the above-described GaN transistor-based regulated voltage sources are able to be used as reference voltage sources for other GaN transistor-based regulated voltage sources. In some examples, a GaN transistor-based regulated voltage source is able to provide a regulated voltage output that is able to be used as a voltage reference for another GaN transistor-based regulated voltage source as well as provide electrical power at a regulated voltage for other loads. In some examples, the output of a GaN transistor-based regulated voltage source is able to incorporate a resistive voltage divider between the GaN regulation transistor and ground in order to reduce the delivered output voltage.

As is understood by practitioners of ordinary skill in the relevant arts in light of the present discussion, the above-described circuits are examples and variations are able to be utilized. Various additional elements are able to be incorporated into circuits to achieve desired results, such as placing capacitors across resistors to speed up or slow down the response of any particular circuit, or placing resistors across capacitors in the circuit to modify response times. As is further understood, any of the above-discussed GaN HEMT devices are able to be replaced with multiple GaN HEMT devices in series, parallel or a combination of both.

The above-described circuits used to realize regulated voltage sources provide advantages over existing regulator circuits by obviating the use of op-amp based, high-gain amplifiers to regulate the output voltage at the reference level. The above-described circuits provide regulated voltage sources with tighter tolerance. The above-described circuits also overcome difficulties in of realizing op-amps using only GaN HEMT devices, which are equivalent to NMOS devices, without using CMOS devices. The above-described circuits implement GaN transistor-based regulated voltage sources that do not use op-amps.

The above-described circuits overcome a challenge in making GaN HEMT based circuits insensitive to, or independent of, the threshold voltage variation of different GaN HEMT devices that are used in a given circuit. The threshold voltage variation between devices produced by typically available processes varies widely, such as by 0.5 V to 2.2 V. The above-described circuits are able to compensate for the GaN threshold voltage variation by constructing circuits that use a pair of GaN HEMT devices that are formed on the same substrate to cancel out their threshold voltages and produce an output at a desired level.

The above-described circuits also support alternatives that allow a Zener-diode/voltage-reference to be connected to the high-rail, i.e., positive voltage supply, or the low-rail, i.e., negative or ground power supply. These alternatives overcome a challenge of conventional series pass linear regulators that have external voltage reference, e.g., a Zener diode, only able to be connected to the low-rail, i.e., the negative or ground supply. In the above example, the Zener diodes are non-GaN devices.

The specification and figures are to be regarded in an illustrative rather than a restrictive sense, and all such modifications are intended to be included within the scope of the present invention. Any benefits, advantages or solutions to problems described herein with regard to specific embodiments are not intended to be construed as a critical, required or essential feature or element of any or all the claims. Unless stated otherwise, terms such as “first” and “second” are used to arbitrarily distinguish between the elements such terms describe.

Thus, these terms are not necessarily intended to indicate temporal or other prioritization of such elements. Note that the term “couple” has been used to denote that one or more additional elements may be interposed between two elements that are coupled such that the one or more additional elements are able to be one of directly coupled without intermediate elements or indirectly coupled in which case intermediate elements are able to be present within the coupling structure.

Although the invention is described herein with reference to specific embodiments, various modifications and changes can be made without departing from the scope of the present invention as set forth in the claims below.

1. A GaN transistor-based regulated voltage source, comprising:
a reference voltage input coupled to an output of a reference voltage source where the reference voltage source produces a reference voltage;
a voltage input port;
a voltage output port;
a GaN transistor-based voltage regulation path coupling the voltage input port and the voltage output port, the GaN transistor-based voltage regulation path comprising a GaN regulation transistor having a threshold voltage and is formed on a substrate; and
a GaN transistor-based voltage compensator comprising an intermediate GaN transistor formed on the substrate, where the GaN transistor-based voltage compensator couples, either one of directly or indirectly, a gate terminal of the GaN regulation transistor to the reference voltage input and introduces a voltage drop between the gate terminal of the GaN regulation transistor and the reference voltage input, where the voltage drop compensates for the threshold voltage of the GaN regulation transistor.

2. The GaN transistor-based regulated voltage source of claim 1, further comprising the reference voltage source, the reference voltage source comprising a Zener diode coupled either directly or indirectly between the intermediate GaN transistor and ground.

3. The GaN transistor-based regulated voltage source of claim 1, further comprising the reference voltage source, the reference voltage source comprising a Zener diode coupled either directly or indirectly between the intermediate GaN transistor and the voltage input port.

4. The GaN transistor-based regulated voltage source of claim 1, where the GaN transistor-based voltage compensator further comprises a potential divider coupled to the voltage output port, the potential divider configured to reduce a voltage at the voltage output port for comparison to the reference voltage.

5. The GaN transistor-based regulated voltage source of claim 1, further comprising a voltage divider coupling the GaN regulation transistor to the voltage output port.

6. The GaN transistor-based regulated voltage source of claim 1, where the GaN transistor-based voltage compensator further comprises a ramp rate control block configured to slow a ramp rate of a gate voltage of the gate terminal.

7. The GaN transistor-based regulated voltage source of claim 6, where the ramp rate control block is configured to limit a voltage ramp rate of the output of the reference voltage source.

8. The GaN transistor-based regulated voltage source of claim 6, where the ramp rate control block couples, either directly or indirectly, the intermediate GaN transistor and the GaN regulation transistor.

9. The GaN transistor-based regulated voltage source of claim 6, where the ramp rate control block further comprises a low pass filter comprising a capacitor coupled to a resistive element of the GaN transistor-based voltage compensator.

10. A GaN transistor-based regulated voltage source, comprising:
a reference voltage source that when operating is configured to produce a reference voltage;
a voltage input port;
a voltage output port;
a GaN transistor-based voltage regulation path coupling the voltage input port and the voltage output port, the GaN transistor-based voltage regulation path comprising a GaN regulation transistor having a threshold voltage and is formed on a substrate; and
a GaN transistor-based voltage compensator comprising an intermediate GaN transistor formed on the substrate, where the GaN transistor-based voltage compensator couples, either one of directly or indirectly, a gate terminal of the GaN regulation transistor to the reference voltage source and introduces a voltage drop between the gate terminal of the GaN regulation transistor and the reference voltage source, where the voltage drop compensates for the threshold voltage of the GaN regulation transistor.

11. The GaN transistor-based regulated voltage source of claim 10, where the GaN transistor-based voltage compensator further comprises a ramp rate control block configured to limit a voltage ramp rate of an output of the reference voltage source.

12. The GaN transistor-based regulated voltage source of claim 10, where the reference voltage source comprises a Zener diode coupled either directly or indirectly between the intermediate GaN transistor and ground.

13. The GaN transistor-based regulated voltage source of claim 10, where reference voltage source comprises a Zener diode coupled either directly or indirectly between the intermediate GaN transistor and the voltage input port.

14. The GaN transistor-based regulated voltage source of claim 10, where the GaN transistor-based voltage compensator further comprises a potential divider coupled to the voltage output port, the potential divider configured to reduce a voltage at the voltage output port for comparison to the reference voltage.

15. The GaN transistor-based regulated voltage source of claim 10, further comprising a voltage divider coupling the GaN regulation transistor to the voltage output port.

16. A GaN transistor-based regulated voltage source, comprising:
a reference voltage input coupled to an output of a reference voltage source where the reference voltage source produces a reference voltage;
a voltage input port;
a voltage output port configured to, when operating, produce a regulated output voltage that is greater than the reference voltage;
a GaN transistor-based voltage regulation path coupling the voltage input port and the voltage output port, the GaN transistor-based voltage regulation path comprising a GaN regulation transistor having a threshold voltage and is formed on a substrate;
an output voltage adjuster configured to, when operating, reduce the regulated output voltage to the reference voltage for comparison to a voltage on the reference voltage input; and
a GaN transistor-based voltage compensator comprising a first intermediate GaN transistor formed on the substrate and a second intermediate GaN transistor formed on the substrate,
where the first intermediate GaN transistor couples, either one of directly or indirectly, a gate terminal of the GaN regulation transistor to the reference voltage input and introduces a voltage drop between the gate terminal of the GaN regulation transistor and the reference voltage input, where the voltage drop compensates for the threshold voltage of the GaN regulation transistor, and
where the second intermediate GaN transistor couples an output of the output voltage adjuster to the gate terminal of the GaN regulation transistor to introduce a voltage increase between the output of the output voltage adjuster and the gate terminal of the GaN regulation transistor, where the voltage increase is based on the voltage drop introduced by the first intermediate GaN transistor.

17. The GaN transistor-based regulated voltage source of claim 16, where the GaN transistor-based voltage compensator further comprises a ramp rate control block configured to slow a ramp rate of a gate voltage of the gate terminal.

18. The GaN transistor-based regulated voltage source of claim 17, where the ramp rate control block is configured to limit a voltage ramp rate of the output of the reference voltage source.

19. The GaN transistor-based regulated voltage source of claim 17, where the ramp rate control block couples, either directly or indirectly, the first intermediate GaN transistor and the GaN regulation transistor.

20. The GaN transistor-based regulated voltage source of claim 17, where the ramp rate control block further comprises a low pass filter comprising a capacitor coupled to a resistive element of the GaN transistor-based voltage compensator.
